(19) United States
(12) Patent Application Publication
(10) Pub. No.: US 2008/0131807 A1
(43) Pub. Date: Jun. 5, 2008

(54) Liquid Developer and Image Forming Apparatus

(75) Inventors: Takashi TESHIMA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/873,232

(22) Filed: Oct. 16, 2007

(30) Foreign Application Priority Data
Dec. 1, 2006 (JP) 2006-326344

(51) Int. Cl. G03G 9/00; G03G 15/10

(52) U.S. Cl. 430/115; 399/239

(57) ABSTRACT

A liquid developer includes: an insulating liquid having dispersed therein toner particles, silica fine particles subjected to hydrophobic treatment and a polymer dispersant, the silica fine particles having an average particle diameter of from 5 to 100 nm, and a content of the silica fine particles being from 0.1 to 5.0 parts by weight per 100 parts by weight of the toner particles, the insulating liquid containing an unsaturated fatty acid triglyceride and a fatty acid monoester.

### BACKGROUND

1. Technical Field

The present invention relates to a liquid developer and an image forming apparatus.

2. Related Art

As a method for forming an image on a recording medium, a method using a liquid developer, which contains toner particles dispersed in an insulating liquid, has been known.

In the method using a liquid developer, toner particles are effectively prevented from being aggregated, as compared to a dry toner using a toner in a dry state, whereby finer toner particles can be used, and a binder resin having a lower softening point (lower softening temperature) can be used. Accordingly, an image forming apparatus using a liquid developer has such characteristics in that a thin line image is well reproduced, and an image having good gradation reproducibility and excellent color reproducibility can be obtained.

As the insulating liquid used for a liquid developer, a petroleum hydrocarbon, a silicone oil and the like are used owing to the high chemical stability.

A method using a liquid developer, however, has environmental issues due to evaporation of the insulating liquid upon using for fixation and disposal of the liquid developer. Furthermore, the insulating liquid attached to the surface of the toner particles permeates a recording medium upon fixing to cause a problem of decreasing fixing strength. The permeation of the insulating liquid also brings about such a problem in that the recording medium is prevented from being marked with a ballpoint pen or the like.

Such an attempt has been made for solving the problems that a naturally derived oil, such as vegetable oil, is used to improve fixing strength through oxidation polymerization reaction of the oil upon fixing (as described, for example, in JP-A-2006-251252.

However, the fixing strength is improved with the liquid developer using a naturally derived oil, but toner particles cannot be sufficiently charged to fail to obtain sufficient charging property.

### SUMMARY

An object of the invention is to provide such a liquid developer that is environmentally benign and is excellent in charging property and fixing property, and an image forming apparatus using the same.

According to an aspect of the invention, a liquid developer is provided that contains an insulating liquid having dispersed therein toner particles, silica fine particles subjected to hydrophobic treatment and a polymer dispersant. The silica fine particles have an average particle diameter of from 5 to 100 nm, and a content of the silica fine particles is from 0.1 to 5.0 parts by weight per 100 parts by weight of the toner particles. The insulating liquid contains an unsaturated fatty acid triglyceride and a fatty acid monoester.

A liquid developer that is environmentally benign and is excellent in charging property and fixing property can be provided by the aspect of the invention.

It is preferred in the liquid developer of the aspect of the invention that the silica fine particles have positive charging property.

In this case, a liquid developer that is excellent in positive charging property can be provided. The use of a liquid developer having positive charging property can decrease an amount of discharge products, such as ozone, upon image formation (development), whereby the load on peripheral devices inside an image forming apparatus can be reduced.

It is preferred in the liquid developer of the aspect of the invention that the polymer dispersant is a polyamine-fatty acid polycondensate.

In this case, the charging property of the liquid developer can be effectively improved. Furthermore, the toner particles can be prevented from suffering unintended aggregation, and as a result, the dispersibility of the toner particles in the liquid developer can be further improved. The use of the polyamine-fatty acid polycondensate provides a liquid developer that is excellent in positive charging property. Consequently, the amount of discharge products, such as ozone, upon image formation (development) can be decreased, whereby the load on peripheral devices inside an image forming apparatus can be reduced.

It is preferred in the liquid developer of the aspect of the invention that a content of the polymer dispersant is from 0.5 to 7.5 parts by weight per 100 parts by weight of the toner particles.

In this case, the charging property of the liquid developer can be further effectively improved.

It is preferred in the liquid developer of the aspect of the invention that a content X (% by weight) of the unsaturated fatty acid triglyceride and a content Y (% by weight) of the fatty acid monoester satisfy relationship, 1≦X/Y≦9.

In this case, the fixing property of the toner particles onto a recording medium can be further improved while the excellent charging property is maintained.

It is preferred in the liquid developer of the aspect of the invention that a resin contained in a material constituting the toner particles has an acid value of from 5 to 20 KOHmg/g.

In this case, the silica fine particles and the polymer dispersant can be retained in the vicinity of the surface of the toner particles, whereby the charging property of the liquid developer can be further effectively improved.

According to another aspect of the invention, an image forming apparatus for forming an image on a recording medium by using the liquid developer of the invention is provided. The image forming apparatus of the aspect of the invention contains: a liquid developer storing part that stores the liquid developer; a developing part that forms an image by using the liquid developer fed from the liquid developer storing part; a transferring part that transfers the image formed in the developing part, onto the recording medium to form a transferred image; a recovering part that recovers the liquid developer remaining in the developing part; a transporting part that transports the recovered liquid developer to the liquid developer storing part; and a fixing part that fixes the transferred image formed on the recording medium onto the recording medium.

A sharp image with high quality can be formed by the image forming apparatus.

It is preferred in the image forming apparatus of the aspect of the invention that the developing part contains a developing roller having on a surface thereof a layer of the liquid developer, and a compressing member that localizes the toner particles to a vicinity of a surface of the developing roller within the layer.

In this case, the developing density (developing efficiency) can be improved, whereby a sharp image with high quality can be obtained.

It is preferred in the image forming apparatus of the aspect of the invention that the compressing member applies an electric field having the same polarity as the toner particles to the layer, so as to localize the toner particles to a vicinity of a surface of the developing roller within the layer.

In this case, the developing density (developing efficiency) can be improved, whereby a sharp image with high quality can be obtained.

### BRIEF DESCRIPTION OF THE DRAWINGS

The invention will now be described with reference to the accompanying drawings, wherein like numbers refer to like elements.

FIG. 1 is an illustration showing an example of an image forming apparatus according to an embodiment of the invention.

FIG. 2 is a schematic diagram showing the state of the toner particles in the liquid developer layer.

FIG. 3 is a cross sectional view showing an example of a fixing device used in an image forming apparatus according to an embodiment of the invention.

### DESCRIPTION OF EXEMPLARY EMBODIMENTS

Preferred embodiments of the liquid developer and the image forming apparatus of the invention will be described below.

### Liquid Developer

The liquid developer according to an embodiment of the invention will be described.

The liquid developer of the embodiment of the invention contains an insulating liquid having dispersed therein a polymer dispersant, silica fine particles and toner particles.

### Insulating Liquid

The insulating liquid will be described.

The insulating liquid constituting the liquid developer of the embodiment of the invention contains an unsaturated fatty acid triglyceride having an unsaturated fatty acid as a fatty acid component, and a fatty acid monoester. The unsaturated fatty acid triglyceride referred herein means a fatty acid triglyceride that has at least one unsaturated fatty acid as a fatty acid component in the molecular structure.

A liquid developer has had environmental issues due to an insulating liquid used therein, such as leakage of the insulating liquid outside an image forming apparatus upon use (for example, evaporation of an insulating liquid upon fixing) and disposal of a used liquid developer. A liquid developer also has had a problem of impairing fixing property of toner particles to a recording medium (i.e., decrease in fixing strength) due to the insulating liquid attached to the surface of the toner particles.

On the other hand, an unsaturated fatty acid triglyceride and a fatty acid monoester used in the insulating liquid according to the embodiment of the invention are environmentally benign components. Accordingly, the environmental issues due to the insulating liquid used therein, such as leakage of the insulating liquid outside an image forming apparatus and disposal of a used liquid developer can be reduced. Consequently, an environmentally benign liquid developer can be provided.

The unsaturated fatty acid triglyceride and the fatty acid monoester contain an unsaturated fatty acid component. The unsaturated fatty acid component is a component that contributes to improvement in fixing property of toner particles to a recording medium. More specifically, the unsaturated fatty acid component undergoes polymerization reaction through oxidation (oxidation upon fixing) and is cured by itself, whereby the fixing property of the toner particles can be improved through anchoring effect between the recording medium and the cured liquid developer. According to the mechanism, in the invention, excellent fixing property of the toner particles to the recording medium can be obtained. Furthermore, since the unsaturated fatty acid component is cured, a fixed toner image can be surely marked with a water-based ballpoint pen.

The fatty acid monoester contained in the insulating liquid permeates the resin particles (toner particles) in the fixing process to exhibit plasticizing effect. In the case where paper is used as the recording medium, for example, penetration of the toner particles into fibers of the paper is facilitated through the plasticizing effect, whereby the fixing strength of the toner particles is improved. Furthermore, the toner particles can be fixed at a lower temperature by the plasticizing effect.

The insulating liquid contains both the unsaturated fatty acid triglyceride and the fatty acid monoester. Accordingly, upon storing, the toner particles are prevented from being aggregated with each other to provide excellent storage stability and long-term stability, and upon fixing, the fixing strength of the toner particles to the recording medium can be improved. The phenomena can be understood as follows. The unsaturated fatty acid triglyceride and the fatty acid monoester contained in the insulating liquid are excellent in affinity with the resin material as the major component of the toner particles described later. Accordingly, the toner particles exhibit excellent dispersibility in the insulating liquid, and upon storing, aggregation (blocking) of the toner particles can be effectively prevented, whereby the liquid developer has excellent storage stability and long-term stability. Upon fixing, the liquid developer is applied with heat, whereby the fatty acid monoester permeates the toner particles to exhibit the plasticizing effect, and the toner particles can be firmly fixed on the recording medium thereby.

The use of the insulating liquid containing the unsaturated fatty acid glyceride and the fatty acid monoester enables that the toner particles are fixed to the recording medium at a lower temperature, and particularly exhibit an excellent fixing strength. This can be understood as follows. In general, the fatty acid monoester has a lower viscosity as compared to the unsaturated fatty acid triglyceride. Since the insulating liquid contains both the unsaturated fatty acid triglyceride and the fatty acid monoester, the insulating liquid and the liquid developer have an appropriate viscosity, whereby permeation of the liquid developer into the recording medium can be optimized. Furthermore, the insulating liquid containing the toner particles is cured through oxidation polymerization reaction of the unsaturated fatty acid component in the insulating liquid, whereby the toner particles can be firmly fixed to the recording medium through anchoring effect between the cured liquid developer and the recording medium.

The content of the unsaturated fatty acid triglyceride in the insulating liquid is preferably from 55 to 90% by weight, and more preferably from 57 to 75% by weight. The liquid developer satisfying the condition is particularly excellent in storage stability and long-term stability.

The content of the fatty acid monoester in the insulating liquid is preferably from 10 to 45% by weight, and more preferably from 25 to 43% by weight. According to the constitution, permeation of the fatty acid monoester into the toner particles upon fixing is further improved, whereby the plasticizing effect is surely exhibited. Consequently, the fixing property of the toner particles to the recording medium can be further improved.

The ratio of the unsaturated fatty acid triglyceride and the fatty acid monoester in the insulating liquid is not particularly limited and preferably satisfies the following relationship. The content X (% by weight) of the unsaturated fatty acid triglyceride and the content Y (% by weight) of the fatty acid monoester in the insulating liquid preferably satisfy relationship, 1≦X/Y≦9, and more preferably satisfy relationship, 1.4≦X/Y≦4. According to the constitution, upon storing, the fatty acid monoester can be suitably suppressed from permeating the toner particles, and upon fixing, the fatty acid monoester sufficiently permeates the toner particles to provide the plasticizing effect surely. Consequently, the fixing property of the toner particles to the recording medium can be still further improved while the excellent charging property is maintained.

### Unsaturated Fatty Acid Triglyceride

The unsaturated fatty acid triglyceride in the insulating liquid of the embodiment of the invention is a triester between a fatty acid and glycerin (i.e., a triglyceride), and contains an unsaturated fatty acid as a fatty acid component.

The unsaturated fatty acid triglyceride in the insulating liquid contains an unsaturated fatty acid as a fatty acid component, whereby the toner particles can be firmly fixed to the recording medium. Examples of the unsaturated fatty acid component include a monobasic unsaturated fatty acid, such as oleic acid and palmitoleic acid, a polybasic unsaturated fatty acid having plural double bonds in the molecule, such as linoleic acid, α-linolenic acid, γ-linolenic acid, arachidonic acid, docosahexaenoic acid (DHA) and eicosapentaenoic acid (EPA), and a conjugated unsaturated fatty acid. In the case where the insulating liquid contains the unsaturated fatty acid triglyceride containing a conjugated unsaturated fatty acid as a fatty acid component, in particular, the chemical stability and the electric insulating property can be effectively improved upon storing although the component contributes to the oxidation polymerization reaction. This is because the conjugated unsaturated fatty acid is chemically stable as compared to a non-conjugated unsaturated fatty acid. Accordingly, the charging property of the liquid developer can be effectively improved while the excellent fixing property is maintained.

Among the unsaturated fatty acid components described above, the monobasic unsaturated fatty acid particularly has excellent chemical stability. Accordingly, in the case where the unsaturated fatty acid triglyceride in the insulating liquid contains the monobasic fatty acid as a fatty acid component, the liquid developer is improved in storage stability and long-term stability. The polybasic unsaturated fatty acid, on the other hand, has high reactivity (oxidation reactivity) as compared to the monobasic unsaturated fatty acid. Accordingly, in the case where the unsaturated fatty acid triglyceride in the insulating liquid contains the polybasic unsaturated fatty acid as a fatty acid component, the oxidation polymerization reaction of the insulating liquid favorably proceeds upon fixing, whereby the toner particles can be firmly fixed to the recording medium.

In the case where the unsaturated fatty acid triglyceride contains a saturated fatty acid as a fatty acid component, in addition to the unsaturated fatty acid, the chemical stability and the electric insulating property of the liquid developer can be maintained at high levels. Accordingly, the liquid developer can be prevented from suffering chemical change, and the electric resistance thereof can be maintained at a high level, whereby the charging property of the liquid developer can be effectively improved. Examples of the saturated fatty acid include butyric acid, caproic acid, caprylic acid, capric acid, lauric acid, myristic acid, palmitic acid, stearic acid, arachidinic acid, behenic acid and lignoceric acid.

The unsaturated fatty acid triglyceride can be obtained efficiently by purifying such a naturally-derived oil as an oil derived from vegetables, such as soybean oil, rapeseed oil, safflower oil, sunflower oil, linseed oil, olive oil, corn oil, camellia oil, cotton seed oil, dehydrated caster oil, palm kernel oil and coconut oil, and an oil derived from animals, such as herring oil and sardine oil. Examples of the purification method include such a method in that an unpurified oil is mixed with boiling water, and after completely separating the mixture into three layers, a component that freezes in a freezing chamber is removed. The method may be repeatedly carried out to provide the unsaturated fatty acid triglyceride having higher purity.

The unsaturated fatty acid triglyceride preferably contains a monobasic unsaturated fatty acid in an amount of from 15 to 80% by mol, and more preferably from 20 to 75% by mol, based on the total fatty acid components. According to the constitution, the storage stability and the long-term stability of the liquid developer can be particularly improved.

The unsaturated fatty acid triglyceride preferably contains a polybasic unsaturated fatty acid in an amount of from 10 to 75% by mol, and more preferably from 15 to 65% by mol, based on the total fatty acid components. According to the constitution, the toner particles can be fixed to the recording medium further firmly.

The unsaturated fatty acid triglyceride preferably contains a saturated fatty acid component in an amount of from 5 to 20% by mol, and more preferably from 7 to 17% by mol, based on the total fatty acid components. According to the constitution, the storage stability and the long-term stability of the liquid developer can be particularly improved.

### Fatty Acid Monoester

The fatty acid monoester in the insulating liquid in the embodiment of the invention is a monoester between a fatty acid and a monohydric alcohol, and contains an unsaturated acid as a fatty acid component.

The fatty acid monoester preferably contains an unsaturated fatty acid having from 16 to 22 carbon atoms as a fatty acid component. According to the constitution, the unsaturated fatty acid monoester appropriately permeates the toner particles upon fixing, whereby the fatty acid monoester sufficiently exhibits effect of a plasticizer. Furthermore, the insulating liquid appropriately permeates the recording medium, and the liquid developer is appropriately cured through oxidation polymerization reaction. Owing to these advantages, the fixing property of the toner particles to the recording medium is particularly improved. Examples of the unsaturated fatty acid component include a monobasic unsaturated fatty acid, such as oleic acid and palmitoleic acid, a polybasic unsaturated fatty acid having plural double bonds in the molecule, such as linoleic acid, α-linolenic acid, γ-linolenic acid, arachidonic acid, docosahexaenoic acid (DHA) and eicosapentaenoic acid (EPA), and a conjugated unsaturated fatty acid. In the case where the insulating liquid contains the fatty acid monoester containing a conjugated unsaturated fatty acid as a fatty acid component, in particular, the chemical stability and the electric insulating property can be effectively improved upon storing although the component contributes to the oxidation polymerization reaction. This is because the conjugated unsaturated fatty acid is chemically stable as compared to a non-conjugated unsaturated fatty acid. Accordingly, the charging property of the liquid developer can be effectively improved while the excellent fixing property is maintained.

Among the unsaturated fatty acid components described above, the monobasic unsaturated fatty acid particularly has excellent chemical stability. Accordingly, in the case where the fatty acid monoester in the insulating liquid contains the monobasic unsaturated fatty acid as a fatty acid component, the liquid developer is improved in storage stability and long-term stability. The polybasic unsaturated fatty acid, on the other hand, has high reactivity (oxidation reactivity) as compared to the monobasic unsaturated fatty acid. Accordingly, in the case where the fatty acid monoester in the insulating liquid contains the polybasic unsaturated fatty acid as a fatty acid component, the oxidation polymerization reaction of the insulating liquid favorably proceeds upon fixing, whereby the toner particles can be firmly fixed to the recording medium.

The fatty acid component of the fatty acid monoester contains mainly an unsaturated fatty acid and may contains partially a saturated fatty acid. Examples of the saturated fatty acid include butyric acid, caproic acid, caprylic acid, capric acid, lauric acid, myristic acid, palmitic acid, stearic acid, arachidinic acid, behenic acid and lignoceric acid.

The fatty acid monoester constituting the insulating liquid is preferably one produced through ester exchange reaction between a fatty acid glyceride and a monohydric alcohol having from 1 to 4 carbon atoms. According to the constitution, the affinity between the fatty acid monoester and the fatty acid glyceride is further improved to make the viscosity of the insulating liquid more appropriate, whereby permeation of the liquid developer into the recording medium can be further improved. Accordingly, the fixing strength of the toner particles to the recording medium is improved, whereby the liquid developer can be favorably used as one suitable for high-speed image formation.

The fatty acid monoester preferably contains a fatty acid monoester constituted by a monobasic unsaturated fatty acid as a fatty acid component in an amount of from 10 to 75% by mol, and more preferably from 20 to 65% by mol, based on the total amount of the fatty acid monoester. According to the constitution, the storage stability and the long-term stability of the liquid developer can be particularly improved.

The fatty acid monoester preferably contains a fatty acid monoester constituted by a polybasic unsaturated fatty acid in an amount of from 15 to 80% by mol, and more preferably from 20 to 70% by mol, based on the total amount of the fatty acid monoester. According to the constitution, the toner particles can be fixed to the recording medium further firmly.

The fatty acid monoester preferably contains a fatty acid monoester constituted by a saturated fatty acid component in an amount of from 5 to 20% by mol, and more preferably from 10 to 18% by mol, based on the total amount of the fatty acid monoester. According to the constitution, the charging property of the liquid developer can be further effectively improved.

### Silica Fine Particles

The silica fine particles constituting the liquid developer of the embodiment of the invention will be described.

The liquid developer of the embodiment of the invention contains silica fine particles having an average particle diameter of from 5 to 100 nm and having been subjected to hydrophobic treatment in an amount of from 0.1 to 5.0 parts by weight per 100 parts by weight of the toner particles.

In a liquid developer using a naturally derived oil, it has been difficult to obtain sufficient charging property due to difficulty in charging toner particles sufficiently although the fixing strength has been improved.

In the embodiment of the invention, on the other hand, the liquid developer contains the silica fine particles subjected to hydrophobic treatment having an average particle diameter of from 5 to 100 nm in the prescribed amount, whereby the toner particles can be firmly fixed to the recording medium, and the charging property of the liquid developer can be improved. It is understood that this is because of the following factors.

The silica fine particles subjected to hydrophobic treatment are particles having high charging property and impart high charging property to the liquid developer by attaching (being localized) to the surface of the toner particles. However, the silica particles cannot be sufficiently localized to the surface of the toner particles only by adding the silica fine particles to the liquid developer, which brings about failure in exhibition of sufficient charging property of the liquid developer. In the embodiment of the invention, the silica fine particles having an average particle diameter of from 5 to 100 nm are added in the prescribed amount, whereby the silica fine particles can be surely localized to the surface of the toner particles in an appropriate amount. As a result, toner particles can be surely charged to improve the charging property of the liquid developer. Furthermore, since the silica fine particles are localized to the surface of the toner particles, the polymer dispersant described later can be surely attached to the surface of the toner particles to improve particularly the charging property of the liquid developer.

The silica fine particles constituting the liquid developer of the embodiment of the invention have an average particle diameter of from 5 to 100 nm, preferably from 10 to 80 nm, and more preferably from 20 to 60 nm. According to the constitution, the silica fine particles can be attached to the surface of the toner particles further surely, and the polymer dispersant described later can be surely localized in the vicinity of the surface of the toner particles. In the case where the average particle diameter of the silica fine particles is less than the lower limit, the silica fine particles float in the insulating liquid, whereby it is difficult to attach the silica fine particles to the surface of the toner particles. As a result, it is difficult to localize the polymer dispersant described later to the vicinity of the surface of the toner particles, whereby it is difficult to improve sufficiently the charging property of the liquid developer. Furthermore, upon printing repeatedly, the silica fine particles are accumulated in a liquid developer storing part of an image forming apparatus described later to increase the viscosity of the liquid developer in the liquid developer storing part. Consequently, unevenness occurs in transporting property (transferring property) of the liquid developer, and unevenness occurs in an image finally obtained. In the case where the average particle diameter of the silica fine particles exceeds the upper limit, on the other hand, the silica fine particles are liable to be released from the surface of the toner particles, and it is difficult to localize the polymer dispersant to the vicinity of the surface of the toner particles, whereby it is difficult to improve sufficiently the charging property of the liquid developer, as similar to the above.

The content of the silica fine particles contained in the liquid developer of the embodiment of the invention is from 0.1 to 5.0 parts by weight per 100 parts by weight of the toner particles, and it is preferably from 0.2 to 3.0 parts by weight, and more preferably from 0.5 to 2.0 parts by weight. According to the constitution, the silica fine particles can be attached to the surface of the toner particles in a further appropriate amount to improve the charging property of the liquid developer further effectively. In the case where the content of the silica fine particles is less than the lower limit, the amount of the silica fine particles that are attached to the surface of the toner particles is decreased to fail to provide sufficient charging property. Furthermore, it becomes difficult to localize the polymer dispersant described later to the vicinity of the surface of the toner particles, whereby it becomes difficult to improve sufficiently the charging property of the liquid developer. In the case where the content of the silica fine particles exceeds the upper limit, on the other hand, the amount of the silica fine particles that are released from the surface of the toner particles is increased, and upon printing repeatedly, the silica fine particles are accumulated in a liquid developer storing part of an image forming apparatus described later to increase the viscosity of the liquid developer in the liquid developer storing part. Consequently, unevenness occurs in transporting property (transferring property) of the liquid developer, and unevenness occurs in an image finally obtained. Furthermore, a too large content of the silica fine particles brings about deterioration in fixing property of the toner particles in some cases.

The hydrophobic silica particles used preferably have positive charging property. The use of the silica fine particles having positive charging property provides the liquid developer that is excellent in positive charging property. The use of a liquid developer having positive charging property can decrease an amount of discharge products, such as ozone, upon image formation (development), whereby the load on peripheral devices inside an image forming apparatus can be reduced.

The silica fine particles having positive charging property can be produced in any manner, and for example can be obtained by effecting surface treatment with a silane coupling agent having a functional group, such as an amino group.

### Polymer Dispersant

In the embodiment of the invention, a polymer dispersant is contained in the liquid developer (insulating liquid).

The polymer dispersant has a function of improving the dispersibility of the toner particles and also has a function of improving the charging property of the liquid developer.

In the embodiment of the invention, particularly, the polymer dispersant is localized in the vicinity of the surface of the toner particles owing to the use of the silica fine particles. Accordingly, the toner particles can have high dispersibility, and the liquid developer can be particularly improved in charging property.

Examples of the polymer dispersant include a polyamine-fatty acid polycondensate, polyvinyl alcohol, carboxymethylcellulose, polyethylene glycol, a polycarboxylic acid and a salt thereof, a polyacrylic acid metallic salt (such as a sodium salt), a polymethacrylic acid metallic salt (such as a sodium salt), a polymaleic acid metallic salt (such as a sodium salt), an acrylic acid-maleic acid copolymer metallic salt (such as a sodium salt), a polystyrenesulfonic acid metallic salt (such as a sodium salt) and an ammonium salt.

Among these, in particular, the polymer dispersant can be firmly attached to the surface of the toner particles by using a polyamine-fatty acid polycondensate, whereby the charging property of the liquid developer can be effectively improved. Furthermore, the toner particles can be prevented from suffering unintended aggregation, and as a result, the dispersibility of the toner particles in the liquid developer can be further improved. The use of the polyamine-fatty acid polycondensate provides the liquid developer that is excellent in positive charging property. Consequently, the amount of discharge products, such as ozone, upon image formation (development) can be decreased, whereby the load on peripheral devices inside an image forming apparatus can be reduced. The advantage can be conspicuously exhibited in the case where a polyester resin is used as a resin material constituting the toner particles. More specifically, a polyester resin has high transparency and provides, upon using as a hinder resin, an image having good coloring property with high fixing property. However, in general, it is difficult to apply a polyester resin to toner particles (liquid developer) having positive charging property due to the negative charging property thereof. By using the polyamine-fatty acid polycondensate, on the other hand, the liquid developer that is excellent in positive charging property can be obtained even in the case where a polyester resin is used.

The content of the polymer dispersant in the liquid developer is preferably from 0.5 to 7.5 parts by weight, and more preferably from 1 to 5 parts by weight, per 100 parts by weight of the toner particles. According to the constitution, the charging property of the liquid developer can be improved further effectively.

### Toner Particles

The toner particles will be described.

### Constitutional Material of Toner Particles (Toner Material)

The liquid developer of the embodiment of the invention contains toner particles dispersed in the liquid developer having the aforementioned constitution.

The toner particles (toner) constituting the liquid developer contain at least a resin material.

### 1. Resin Material

The toner constituting the liquid developer is constituted by a material containing a resin material as the major component.

The resin (binder resin) is not particularly limited in the invention, and for example, a known resin can be used, with the use of a polyester resin being preferred. A polyester resin has an ester component in the molecular structure, as similar to the fatty acid monoester and the unsaturated fatty acid triglyceride described above, and thus has high affinity with the insulating liquid to provide particularly high dispersibility of the toner particles in the liquid developer. Upon fixing, permeation of the fatty acid monoester therein is facilitated to exhibit surely the plasticizing effect, whereby the fixing property can be further improved. The toner particles constituted by a material containing a polyester resin have various kinds of functional groups on the surface thereof, and the silica fine particles can be readily attached thereto to provide particularly improved charging property of the liquid developer. Furthermore, a polyester resin has high transparency, and provides, upon using as a binder resin, an image having good coloring property.

The resin preferably has an acid value of from 5 to 20 KOHmg/g, and more preferably from 5 to 10 KOHmg/g. According to the constitution, the silica fine particles and the polymer dispersant can be retained further effectively in the vicinity of the surface of the toner particles, whereby the charging property of the liquid developer can be further effectively improved. The toner particles that are constituted by the resin material satisfying the conditions are excellent in affinity with the insulating liquid. Accordingly, upon storing, the dispersibility of the toner particles in the liquid developer is improved, and the toner particles can be prevented further effectively from being aggregated with each other for a prolonged period of time. Upon fixing, furthermore, the insulating liquid (fatty acid monoester) favorably permeates the toner particles to exhibit the plasticizing effect strongly, whereby the toner particles can be firmly fixed to the recording medium.

The softening temperature of the resin (resin material) is not particularly limited and is preferably from 50 to 130° C., more preferably from 50 to 120° C., and further preferably from 60 to 115° C. The softening temperature referred herein means a softening starting temperature determined with a Koka-type flow tester (produced by Shimadzu Corp.) under measuring conditions of a temperature increasing rate of 5° C. per minute and a die hole diameter of 1.0 mm.

### 2. Colorant

The toner may contain a colorant. The colorant is not particularly limited, and for example, a pigment, a dye and the like having been known may be used.

### 3. Other Components

The toner may contain other components than those described above. Examples of the components include wax and magnetic powder having been known.

A kneaded material constituting the toner may contain other constitutional materials (components) than those described above, for example, zinc stearate, zinc oxide, cerium oxide, silica, titanium oxide, iron oxide, a fatty acid, a fatty acid metallic salt and the like may be used.

### Shape, etc. of Toner Particles

The toner particles used in the liquid developer of the embodiment of the invention preferably have minute unevenness on the surface thereof. By providing the minute unevenness, the fatty acid monoester can be effectively localized (adsorbed) in the vicinity of the toner particles.

The toner particles constituted by the aforementioned materials preferably have an average particle diameter of from 0.1 to 5 μm, more preferably from 0.1 to 4 μm, and further preferably from 0.5 to 3 μm. In the case where the average particle diameter of the toner particles is in the range, a resolution of an image formed with the liquid developer (toner) can be sufficiently increased.

The content of the toner particles in the liquid developer is preferably from 10 to 60% by weight, and more preferably from 20 to 50% by weight.

The viscosity (viscosity measured with a vibration viscometer at 25° C. according to JIS Z8809) of the liquid developer constituted by the aforementioned components (i.e., the liquid developer of the embodiment of the invention) is preferably from 50 to 1,000 mPa·s, more preferably from 100 to 900 mPa·s, and further preferably from 150 to 800 mPa·s. According to the constitution, the liquid developer appropriately permeates the recording medium, whereby the fixing property of the toner particles to the recording medium is improved. Furthermore, an image obtained on the recording medium becomes sharp without unevenness, and moreover, the liquid developer becomes suitable particularly for high-speed image formation. In the case where the fatty acid monoester is not contained, however, the viscosity of the insulating liquid becomes too high, and the toner particles having a large amount of the insulating liquid attached to the surface thereof are fixed to the recording medium. In the case where a large amount of the insulating liquid is attached to the surface of the toner particles, there is a possibility in that the fixing property of the toner particles to the recording medium is deteriorated due to difficulty in permeation of the insulating liquid into the recording medium, so as to make high-speed image formation difficult. Furthermore, the plasticizing effect cannot be sufficiently exhibited to fail to obtain improvement in fixing property. In the case where the unsaturated fatty acid triglyceride is not contained, the viscosity of the insulating liquid becomes too low. Accordingly, in an image forming apparatus described later, for example, it becomes difficult to pick up the liquid developer with a coating roller from a developer container, whereby the toner particles may not be fixed uniformly to the recording medium. Consequently, there is a possibility in that the resulting image suffers unevenness with a low image density, and the fixing property of the toner particles to the recording medium becomes insufficient.

The electric resistance of the liquid developer constituted by the aforementioned components (i.e., the liquid developer of the embodiment of the invention) is preferably 1.5×10¹² Ω·cm or more, and more preferably 2.0×10¹² Ω·cm or more.

### Production Method of Liquid Developer

The production method of the liquid developer of the embodiment of the invention will be described.

The production method of the liquid developer according to one embodiment of the invention contains: aggregating resin fine particles constituted mainly by a resin material to form aggregated particles; pulverizing the aggregated particles in the fatty acid monoester or a mixed liquid of the fatty acid monoester and a part of the unsaturated fatty acid triglyceride (which may be referred to as a fatty acid ester liquid for pulverization) to form a toner particle dispersion liquid having toner particles dispersed in the fatty acid ester liquid for pulverization; and mixing the resulting toner particle dispersion liquid with the fatty acid triglyceride.

### Preparation of Aggregated Particles

An example of a preparation method of the aggregated particles obtained by aggregating resin fine particles constituted mainly by a resin material will be described.

The aggregated particles may be prepared by any method, and in this embodiment, the aggregated particles are obtained in such a manner that an aqueous dispersion liquid containing a dispersoid (fine particles) constituted mainly by a resin material (toner material) dispersed in an aqueous dispersion medium constituted by an aqueous liquid is obtained, and the dispersoid in the aqueous dispersion liquid is aggregated to provide aggregated particles.

### Preparation of Aqueous Dispersion Liquid

Preparation of the aqueous dispersion liquid will be described.

The aqueous dispersion liquid may be prepared by any method, and in this embodiment, the aqueous dispersion liquid is obtained in the following manner. The toner material is dissolved in a solvent to provide a toner material solution, and the toner material solution and an aqueous dispersion medium constituted by an aqueous liquid are mixed to provide an aqueous emulsion having a dispersoid (liquid dispersoid) containing the toner material dispersed therein. Thereafter, at least a part of the solvent contained in the aqueous emulsion is removed to provide an aqueous dispersion liquid.

The aqueous emulsion can be prepared, for example, by the following manner (preparation of the aqueous emulsion).

An aqueous dispersion medium is prepared.

The aqueous dispersion medium is constituted by an aqueous liquid.

The aqueous liquid referred herein means a liquid constituted by water and/or a liquid excellent incompatibility with water (for example, a liquid having a solubility of 30 g or more in 100 g of water at 25° C.). The aqueous liquid is constituted by water and/or a liquid excellent in compatibility with water, and is preferably constituted mainly by water. The content of water is preferably 70% by weight or more, and more preferably 90% by weight or more. By using the aqueous liquid, the dispersibility of the dispersoid in the aqueous dispersion medium can be improved, whereby the dispersoid in the aqueous emulsion has a relatively small particle diameter with less fluctuation in size. As a result, the toner particles in the liquid developer finally obtained have small fluctuation in size and shape among the particles and have a high circularity.

Specific examples of the aqueous liquid include water, an alcohol solvent, such as methanol, ethanol and propanol, an ether solvent, such as 1,4-dioxane and tetrahydrofuran (THF), an aromatic heterocyclic solvent, such as pyridine, pyrazine and pyrrole, an amide solvent, such as N,N-dimethylformamide (DMF) and N,N-dimethylacetamide (DMA), a nitrile solvent, such as acetonitrile, and an aldehyde solvent, such as acetoaldehyde.

An emulsification dispersant may be added to the aqueous dispersion medium depending on necessity. The aqueous emulsion can be prepared easily by adding an emulsification dispersant.

The emulsification dispersant is not particularly limited, and known emulsification dispersants may be used.

The toner material is dissolved in a solvent to prepare a toner material solution.

The solvent is not limited as far as it dissolves at least a part of the toner material, and a solvent having a boiling point that is lower than that of the aqueous liquid is preferably used. According to the constitution, the solvent can be easily removed.

The solvent preferably has low compatibility with the aqueous dispersion medium (aqueous liquid) (for example, a liquid having a solubility of 30 g or less in 100 g of aqueous dispersion medium at 25° C.). According to the constitution, the toner material can be finely dispersed in the aqueous emulsion in a stable manner.

The composition of the solvent may be appropriately selected depending, for example, on the compositions of the known resin and the colorant and the composition of the aqueous dispersion medium.

The solvent is not particularly limited, and examples thereof include a ketone solvent, such as MEK, and an aromatic hydrocarbon solvent, such as toluene.

A kneaded product obtained by kneading the materials for the toner, such as the resin material and the colorant, may be used for preparing the toner material solution. By using the kneaded product, the materials for constituting the toner can be in a sufficiently mixed and finely dispersed state by kneading even though the materials include such components that are less dispersible or compatible with each other. In the case where a pigment (colorant) that has relatively poor dispersibility to the solvent is used, particularly, the periphery of the pigment particles is effectively coated with the resin component and the like by preliminarily kneading before dispersing in the solvent, whereby the dispersibility of the pigment in the solvent is improved (i.e., the pigment can be finely dispersed in the solvent), and the coloring property of the toner finally obtained is also improved. Accordingly, even in the case where a component that is poor in dispersibility in the aqueous dispersion medium of the aqueous emulsion or a component that is poor in solubility in the solvent contained in the dispersion medium of the aqueous emulsion is contained, the dispersibility of the dispersoid in the aqueous emulsion can be particularly improved.

Subsequently, the toner material solution is gradually added dropwise to the aqueous dispersion medium under stirring, whereby the aqueous emulsion having the dispersoid containing the toner material dispersed therein can be obtained. Upon adding the toner material solution dropwise, the aqueous dispersion medium and/or the toner material solution may be heated.

Thereafter, the resulting aqueous emulsion is heated or allowed to stand under a reduced pressure for removing at least a part of the solvent contained in the dispersoid, whereby the aqueous dispersion liquid having the dispersoid (fine particles) constituted by the toner material dispersed therein is obtained.

The content of the dispersoid in the aqueous dispersion liquid is not particularly limited and is preferably from 5 to 55% by weight, and more preferably from 10 to 50% by weight. According to the constitution, the productivity of the toner particles (liquid developer) can be particularly improved while the dispersoid is effectively prevented from suffering unintended aggregation in the aqueous dispersion liquid.

The average particle diameter of the dispersoid in the aqueous dispersion liquid is not particularly limited and is preferably from 0.01 to 3 μm, and more preferably from 0.1 to 2 μm. According to the constitution, the size of the toner particles finally obtained can be optimized. The term “average particle diameter” referred herein means a volume average particle diameter.

### Formation of Aggregated Particles

An electrolyte is added to the aqueous dispersion liquid thus obtained, whereby the dispersoid is aggregated to provide aggregated particles (formation of aggregated particles).

Examples of the electrolyte to be added include an acidic substance, such as hydrochloric acid, sulfuric acid, phosphoric acid, acetic acid and oxalic acid, and an organic or inorganic water-soluble salt, such as sodium sulfate, ammonium sulfate, potassium sulfate, magnesium sulfate, sodium phosphate, sodium dihydrogenphosphate, sodium chloride, potassium chloride, ammonium chloride, calcium chloride and sodium acetate, and these substances may be used solely or in combination of plural kinds of them. Among these, a sulfate of a monovalent cation, such as sodium sulfate and ammonium sulfate, is preferably used for attaining uniform aggregation.

Before adding the electrolyte and the like, an inorganic dispersion stabilizer, such as hydroxyapatite, and an ionic or nonionic surfactant may be added. In the case where the electrolyte is added in the presence of the dispersion stabilizer (emulsifier), uneven aggregation can be prevented from occurring.

Examples of the dispersion stabilizer include a nonionic surfactant, such as polyoxyethylene nonylphenyl ether, polyoxyethylene octylphenyl ether, polyoxyethylene decylphenyl ether, polyoxyethylene alkyl ether, polyoxyethylene fatty acid ester, sorbitan fatty acid ester, polyoxyethylene sorbitan fatty acid ester and various kinds of Pluronic series surfactant, an anionic surfactant such as alkyl sulfuric ester salt surfactant, and a cationic surfactant, such as a quaternary ammonium salt surfactant. Among these, an anionic or nonionic surfactant is preferred since it is effective for improving dispersion stability with only a small addition amount. The nonionic surfactant preferably has a clouding point of 40° C. or more.

The amount of the electrolyte added is preferably from 0.5 to 15 parts by weight, more preferably from 1 to 12 parts by weight, and further preferably from 1 to 10 parts by weight, per 100 parts by weight of the solid content in the aqueous dispersion liquid. In the case where the addition amount of the electrolyte is less than the lower limit, there are some cases where aggregation of the dispersoid cannot sufficiently proceed. In the case where the addition amount of the electrolyte exceeds the upper limit, there is a possibility in that aggregation of the dispersoid proceeds unevenly to form coarse particles, whereby the toner particles finally obtained suffer fluctuation in size.

After the aggregation operation, aggregated particles are obtained by carrying out such operations as filtering, washing and drying.

The average particle diameter of the resulting aggregated particles is preferably from 0.1 to 7 μm, and more preferably from 0.5 to 3 μm. According to the constitution, the toner particles finally obtained can have an appropriate particle diameter.

### Pulverization

The aggregated particles thus obtained are pulverized in the fatty acid ester liquid for pulverization (pulverization). According to the operation, a toner particle dispersion liquid having the toner particles dispersed in the fatty acid ester liquid for pulverization is obtained.

The aggregated particles are pulverized in the fatty acid ester liquid for pulverization, whereby the fatty acid monoester contained in the fatty acid ester liquid for pulverization can be localized (adsorbed) to the vicinity of the surface of the toner particles in the liquid developer finally obtained. The fatty acid monoester is localized to the vicinity of the surface of the toner particles, whereby the plasticizing effect can be conspicuously exhibited. As a result, penetration of the toner particles into the paper fibers (recording medium) is facilitated to improve particularly the fixing strength of the toner particles.

Furthermore, since the aggregated particles are pulverized in the fatty acid ester liquid for pulverization, which is in a liquid state, coarse toner particles due to aggregation can be prevented from being formed.

The resulting toner particles have unevenness derived from the fine particles (dispersoid) on the surface thereof, whereby the fatty acid ester can be surely retained by the unevenness.

In this embodiment, the toner particles are obtained by pulverizing the aggregated particles, whereby fine powder (particles having an excessively smaller size than the intended particles) can be effectively prevented from being formed as compared to the pulverizing method and the wet pulverizing method, which have been practiced. Consequently, deterioration of the charging property of the liquid developer due to the fine powder can be effectively prevented from occurring.

The fatty acid ester liquid for pulverization has a low viscosity and thus easily permeates among the fine particles (dispersoid) to pulverize the aggregated particles favorably.

Upon mixing the fatty acid ester liquid for pulverization and the aggregated particles, the fatty acid ester liquid for pulverization preferably contains the silica fine particles and the polymer dispersant. According to the constitution, the silica fine particles can be surely attached (localized) to the surface of the toner particles, and the polymer dispersant can be localized to the vicinity of the surface of the toner particles. As a result, the charging property of the liquid developer can be further increased. By adding the silica fine particles and the polymer dispersant upon pulverizing, the silica fine particles and the polymer dispersant function as a pulverization assistant to pulverize the aggregated particles further efficiently, and the dispersibility of the resulting toner particles can be further improved.

The silica fine particles and the polymer dispersant may be added upon carrying out a mixing operation described later.

### Mixing

The toner particle dispersion liquid thus obtained and the unsaturated fatty acid triglyceride are mixed to disperse the toner particles in the insulating liquid (mixing).

According to the aforementioned operations, the liquid developer of the embodiment of the invention is obtained, which contains the toner particles, the silica fine particles and the polymer dispersant, which are dispersed in the insulating liquid containing the fatty acid triglyceride and the unsaturated fatty acid monoester.

### Image Forming Apparatus

A preferred embodiment of the image forming apparatus according to an embodiment of the invention will be described.

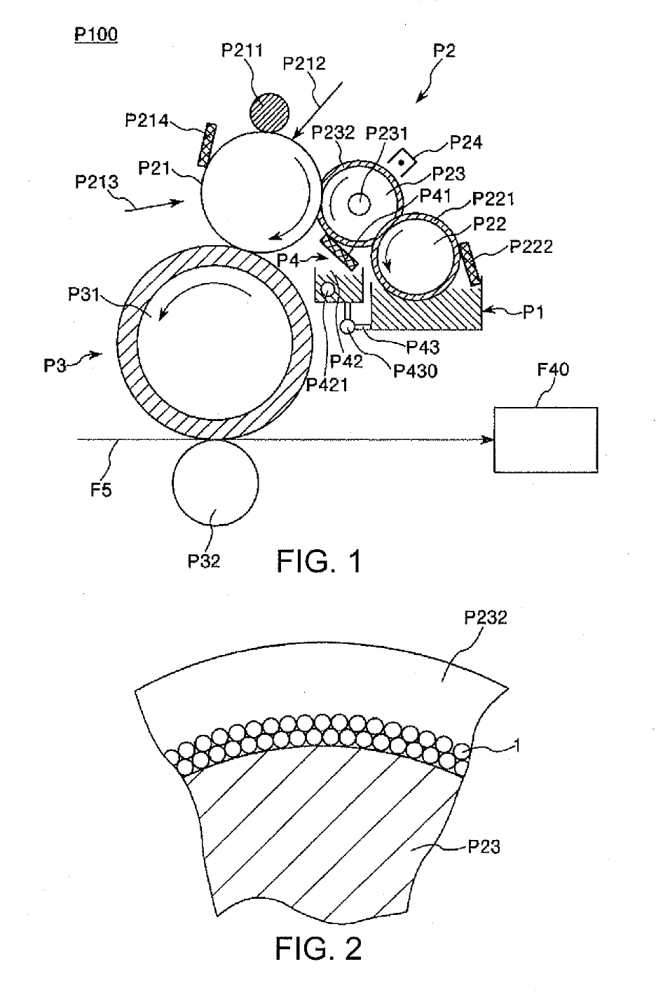

FIG. 1 is an illustration showing an example of an image forming apparatus, to which the liquid developer of the embodiment of the invention is applied.

An image forming apparatus P100 has, as shown in FIG. 1, a liquid developer storing part P1 that stores a liquid developer; a developing part P2 that forms an image (toner image) by using the liquid developer stored in the liquid developer storing part P1; a transferring part P3 that transfers the image formed in the developing part P2, onto a recording medium; a recovering part P4 that recovers the liquid developer becoming redundant in the developing part P2; a recovered liquid developer transporting part (transporting part) P4 that transports the liquid developer having been recovered in the recovering part P4, to the liquid developer storing part P1; and a fixing device (fixing part) F40 described later in detail.

The liquid developer storing part P1 has a function of storing a liquid developer having toner particles dispersed in an insulating liquid.

The developing part P2 has a photoreceptor P21 that forms an image, a liquid feeding roller P22 partially immersed in the liquid developer in the liquid developer storing part P1, and a developing roller P23 that feeds the liquid developer to the photoreceptor P21.

The photoreceptor P21 is uniformly charged on the surface thereof with a charging device (charging roller) P211 constituted by epichlorohydrin rubber or the like, and then exposed corresponding to information to be recorded, with an exposing lamp P212 constituted by a laser diode or the like, so as to provide an electrostatic latent image.

The photoreceptor P21 is an amorphous silicon photoreceptor or an organic photoreceptor having a surface coating layer. According to the constitution, the surface thereof is not abraded with the silica fine particles contained in the liquid developer, and thus the photoreceptor P21 can be prevented from being deteriorated. As a result, the service life of the image forming apparatus can be considerably prolonged.

After transferring the toner image from the photoreceptor P21 to an intermediate transfer roller P31 described later, the photoreceptor P21 is destaticized with destaticizing light P213.

The liquid developer remaining on the photoreceptor P21 after transferring is removed with a cleaning blade P214 constituted by urethane rubber or the like. The liquid developer remaining after transferring contains the silica fine particles and the polymer dispersant and thus can be easily removed without damage on the surface of the photoreceptor P21.

The liquid feeding roller P22 has a function of feeding the liquid developer to the developing roller P23.

The liquid feeding roller P22 is a gravure roller constituted by a metal, such as stainless steel, and is rotated to face the developing roller P23 described later.

A liquid developer feeding layer P221 is provided on the surface of the liquid feeding roller P22, the thickness of which is maintained to a constant value with a metering blade P222. The liquid developer is fed from the liquid feeding roller P22 to the developing roller P23.

The developing roller P23 has a roller core P231 constituted by a metal, such as stainless steel, having thereon a low-hardness silicone rubber layer, and having as the outermost layer a fluorine resin layer constituted by electroconductive PFA (polytetrafluoroethylene-perfluorovinyl ether copolymer) or the like.

The liquid developer is fed from the liquid feeding roller P22 to the surface of the developing roller P23 to form a liquid developer layer P232.

The developing roller P23 is rotated at the same velocity as the photoreceptor P21 for transferring the liquid developer to the latent image.

The developing part P2 has a corona discharging device (compressing member) P24 that discharges electric charge having the same polarity as the toner particles to the liquid developer layer P232 on the developing roller P23, as shown in FIG. 1.

The corona discharging device P24 has a function of applying an electric field having the same polarity as the toner particles to the liquid developer layer 232, and thereby localizing the toner particles 1 to the vicinity of the surface of the developing roller P23 within the liquid developer layer P232. By localizing toner particles in this manner, the developing density (developing efficiency) can be improved, and a sharp image with high quality can be obtained thereby. In particular, since the liquid developer having the toner particles dispersed uniformly therein, the toner particles can be uniformly localized to the vicinity of the surface of the developing roller P23, and can be transferred to the photoreceptor P21 with high efficiency. Consequently, a sharp image with high quality can be formed.

The transferring part P3 has an intermediate transfer roller P31 and a secondary transfer roller P32.

The toner image formed on the photoreceptor P21 is transferred to the intermediate transfer roller P31, and then the secondary transfer roller P32 is electrified to transfer the image to a recording medium F5, such as paper, passing between the intermediate transfer roller P31 and the secondary transfer roller P32.

Thereafter, the toner image (transferred image) transferred on the recording medium F5, such as paper, is conveyed to the fixing device (fixing part) F40 described later for fixing.

The recovering part P4 has a developing roller cleaning blade P41, a recovered liquid developer storing part P42 and a recovered liquid developer transporting part P43.

The developing roller cleaning blade P41 has a function of removing the liquid developer that remains on the developing roller P23 after transferring to the photoreceptor P21.

The recovered liquid developer storing part P42 has a function of recovering and storing the liquid developer that is removed with the developing roller cleaning blade P41.

The toner particles having been localized to the vicinity of the surface of the developing roller P23 with the corona discharging device P24 are recovered in a closely packed state. However, since the liquid developer used contains dispersed therein the silica fine particles, the polymer dispersant and the toner particles, the toner particles can be easily dispersed again even though they are in a closely packed state. It is considered that this is because the presence of the silica fine particles and the polymer dispersant among the toner particles facilitates re-dispersion of the toner particles.

The recovered liquid developer storing part P42 has a stirring member P421 that stirrers the recovered liquid developer. The toner particles in the recovered liquid developer can be uniformly dispersed by providing the stirring member P421, whereby the recovered liquid developer can be favorably reused.

The recovered liquid developer transporting part P43 has a function of transporting the liquid developer stored in the recovered liquid developer storing part P42 to the liquid developer storing part P1.

The recovered liquid developer transporting part P43 has a pump P430 as shown in FIG. 1, and the liquid developer recovered in the recovered liquid developer storing part P42 is transported to the liquid developer storing part P1 with the pump P430.

In this embodiment, a corona charging device is used as the compressing member, but the invention is not limited thereto, and such members as a charging roller, a glow discharging device and the like may be used.

The fixing device applied to the image forming apparatus of the embodiment according to the invention will be described.

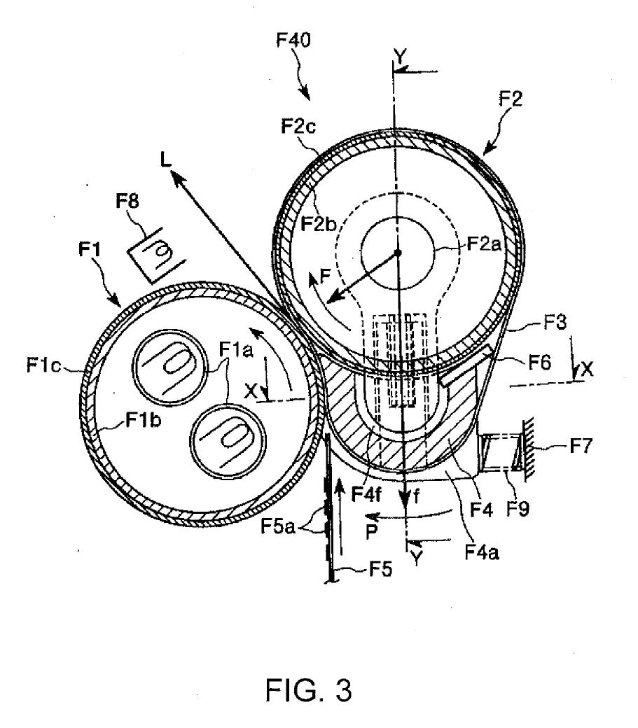

FIG. 3 is a cross sectional view showing an example of the fixing device used in the image forming apparatus of the embodiment according to the invention.

The fixing device (fixing part) F40 fixes the unfixed toner image F5a formed in the developing part P2, the transferring part P3 and the like to the recording medium F5.

The fixing device F40 has a heat fixing roller F1, a pressure roller F2, a heat resistant belt F3, a belt stretching member F4, a cleaning member F5, a frame F7, an ultraviolet ray radiation unit F8 and a spring F9.

The heat fixing roller (fixing roller) F1 has a roller substrate F1b constituted by a tubular member, an elastic member F1c covering the outer periphery of the roller substrate F1b, and columnar halogen lamps F1a inside the roller substrate F1b, and is rotatable in the anticlockwise direction shown by the arrow in the figure.

The pressure roller F2 has a roller substrate F2b constituted by a tubular member, and an elastic member F2c covering the outer periphery of the roller substrate F2b, and is rotatable in the clockwise direction shown by the arrow in the figure.

A PFA layer is provided as a surface layer of the elastic member F1c of the heat fixing roller F1. According to the constitution, the elastic members F1c and F2c undergo elastic deformation in the substantially same manner to form a so-called horizontal nip although the elastic members F1c and F2c are different from each other in thickness, and no difference is formed in conveying speed between the peripheral speed of the heat fixing roller F1 and the speed of the heat resistant belt F3 or the recording medium F5 described later, whereby the image fixing operation can be carried out considerably stably.

Two columnar halogen lamps F1a and F1a constituting a heat source are installed inside the heat fixing roller F1, and heating elements of the columnar halogen lamps F1a and F1a are disposed at positions different from each other. The columnar halogen lamps F1a and F1a are selectively turned on, whereby the temperatures are controlled under different conditions including the fixing nip position where the heat resistant belt F3 described later is wound on the heat fixing roller F1 and the position where the belt stretching member F4 described later is in contact with the heat fixing roller F1, and under different conditions including a recording medium having a large width and a recording medium having a small width.

The pressure roller F2 is disposed to face the heat fixing roller F1 and applies pressure to the recording medium F5 having an unfixed toner image, through the heat resistant belt F3 described later. The insulating liquid can permeate efficiently the recording medium F5 by applying pressure. As a result, the unsaturated fatty acid component contained in the insulating liquid can be surely cured inside the recording medium F5 by heat or irradiation of an ultraviolet ray described later, whereby the toner image F5a can be further firmly fixed to the recording medium F5 through an anchoring effect.

The pressure roller F2 has a roller substrate F2b constituted by a tubular member and an elastic member F2c covering the outer periphery of the roller substrate F2b, and is rotatable in the clockwise direction shown by the arrow in the figure.

The elastic member F1c of the heat fixing roller F1 and the elastic member F2c of the pressure roller F2 undergo elastic deformation in the substantially same manner to form a so-called horizontal nip, and no difference is formed in conveying speed between the peripheral speed of the heat fixing roller F1 and the conveying speed of the heat resistant belt F3 or the recording medium F5 described later, whereby the image fixing operation can be carried out considerably stably.

The heat resistant belt F3 is an endless loop belt that is movably stretched on the outer peripheries of the pressure roller F2 and the stretching member F4 and held under pressure between the heat fixing roller F1 and the pressure roller F2.

The heat resistant belt F3 has a thickness of 0.03 mm or more and is formed of a seamless belt having a two-layer structure containing a front surface (i.e., the side in contact with the recording medium F5) formed of PFA and a back surface (i.e., the side in contact with the pressure roller F2 and the stretching member F4) formed of polyimide. The heat resistant belt F3 is not limited thereto and can be formed of other materials, such as a metallic tube, such as a stainless steel tube and a nickel electroformed tube, and a heat resistant resin tube, such as a silicone tube.

The belt stretching member F4 is disposed on the upstream side of the fixing nip part of the heat fixing roller F1 and the pressure roller F2 in the conveying direction of the recording medium F5 oscillatable in the direction shown by the arrow P with the rotation axis F2a of the pressure roller F2 as the center.

The belt stretching member F4 stretches the heat resistant belt F3 in the tangential direction of the heat fixing roller F1 under the state where the recording medium F5 does not pass through the fixing nip part. There are some cases where the recording medium F5 is not smoothly inserted to the fixing nip part and is wrinkled at the edge thereof upon fixing, in the case where the fixing pressure is too large at the initial position, at which the recording medium F5 is inserted to the fixing nip part. By stretching the heat resistant belt F3 in the tangential direction of the heat fixing roller F1, however, an introducing port, to which the recording medium F5 can be smoothly inserted, can be formed, whereby the recording medium F5 can be stably inserted to the fixing nip part.

The belt stretching member F4 is a belt sliding member having a substantially semilunar shape that is interfit inside the heat resistant belt F3 and applies a tension f to the heat resistant belt F3 associated with the pressure roller F2. The belt stretching member F4 is disposed at such a position that the nip part is formed by winding the heat resistant belt F3 thereon on the side of the heat fixing roller F1 with respect to the tangential direction L of the contact part under pressure of the heat fixing roller F1 and the pressure roller F2. A projected wall F4a is provided as being protruded from one end or both ends in the axial direction of the belt stretching member F4, and in the case where the heat resistant belt F3 is deviated toward one side in the axial direction, the deviation of the heat resistant belt F3 is regulated by making the heat resistant belt F3 in contact with the projected wall F4a. A spring F9 is provided in a compressed state between the side of the projected wall F4a opposite to the heat fixing roller F1 and the frame F7 to press lightly the projected wall F4a of the belt stretching member F4 onto the heat fixing roller F1, whereby the belt stretching member F4 is in contact under sliding with the heat fixing roller F1 for positioning.

The position where the belt stretching member F4 is lightly pressed onto the heat fixing roller F1 forms the nip start position, and the position where the pressure roller F2 is pressed onto the heat fixing roller F1 forms the nip end position.

In the fixing device F40, the recording medium F5 having an unfixed toner image F5a formed thereon is inserted to the fixing nip part from the nip start position, and then it passes between the heat resistant belt F3 and the heat fixing roller F1 and exits from the nip end position, whereby the unfixed toner image F5a formed on the recording medium F5 is fixed under heat. Subsequently, the recording medium F5 is discharged in the tangential direction L of the contact part under pressure of the heat fixing roller F1 and the pressure roller F2.

An ultraviolet ray radiation unit F8 has a function of radiating an ultraviolet ray to the discharged recording medium F5 on the surface thereof having the toner image F5a formed. According to the constitution, the unsaturated fatty acid component contained in the insulating liquid can be firmly cured by irradiation of an ultraviolet ray. As a result, the toner particles can be fixed to the recording medium further firmly. Owing to the irradiation of an ultraviolet ray, the toner particles can be firmly fixed to the recording medium without heating to a particularly high temperature with the heat fixing roller F1, whereby the toner particles can be fixed to the recording medium at a lower temperature and a higher speed, and the toner particles can be fixed to the recording medium further firmly, through the synergistic effect with the use of the liquid developer of the embodiment of the invention. Furthermore, since a large amount of heat energy is not needed for fixing, the toner particles can be sufficiently fixed to the recording medium by irradiation of an ultraviolet ray even when the period of time, for which the recording medium passes the fixing nip part, is relatively short. In other words, the fixing time can be shortened to increase the printing speed. Moreover, since a large amount of heat energy is not needed for fixing, energy saving can be enhanced. Consequently, an environmentally benign fixing device can be provided.

The cleaning member F6 is disposed between the pressure roller F2 and the belt stretching member F4.

The cleaning member F6 is in contact under sliding with the inner surface of the heat resistant belt F3 to clean foreign matters and abrasion powder on the inner surface of the heat resistant belt F3. The heat resistant belt F3 is refreshed by cleaning foreign matters and abrasion powder to reduce the destabilizing factor on friction coefficient described later. A concave portion F4f is provided on the belt stretching member F4 for housing the foreign matters and abrasion powder removed from the heat resistant belt F3.

For stably driving the heat resistant belt F3, which is stretched on the pressure roller F2 and the belt stretching member F4, with the pressure roller F2, the friction coefficient between the pressure roller F2 and the heat resistant belt F3 may be set larger than the friction coefficient between the belt stretching member F4 and the heat resistant belt F3. However, there are cases where the friction coefficient is destabilized due to insertion of foreign matters between the heat resistant belt F3 and the pressure roller F2 or the heat resistant belt F3 and the belt stretching member F4, or abrasion at the contact part of the heat resistant belt F3 with the pressure roller F2 or the belt stretching member F4.

Therefore, the winding angle of the heat resistant belt F3 on the pressure roller F2 is set smaller than the winding angle of the heat resistant belt F3 on the belt stretching member F4, and the diameter of the pressure roller F2 is set smaller than the diameter of the belt stretching member F4. According to the constitution, the length where the heat resistant belt F3 is in contact under sliding on the belt stretching member F4 to avoid the destabilizing factors due to time-lapse deterioration and external disturbance, whereby the heat resistant belt F3 can be stably driven with the pressure roller F2.

The time required for the toner particles passing through the fixing nip part (nip time) is preferably from 0.02 to 0.2 second, and more preferably from 0.03 to 0.1 second. Even with the short period of time required for the toner particles passing through the fixing nip part, the toner particles can be sufficiently fixed owing the use of the liquid developer of the embodiment of the invention, whereby the printing speed can be further improved.

The heat applied by the heat fixing roller F1 (fixing temperature) is preferably from 80 to 200° C., and more preferably from 100 to 180° C. In the case where the fixing temperature is in the range, the oxidation polymerization reaction (curing reaction) of the unsaturated fatty acid component contained in the insulating liquid can proceed further effectively.

The invention has been described with reference to the preferred embodiments, but the invention is not construed as being limited thereto.

For example, the production method of the liquid developer of the invention may contain arbitrary process steps depending on necessity.

The liquid developer of the invention is not limited to those obtained in the methods described above.

The parts and members constituting the image forming apparatus of the invention may be replaced by arbitrary ones that exert the similar functions and may contain other constitutions.

The image forming apparatus of the invention is not limited to those having the constitution shown by the figures.

The fixing device applied to the image forming apparatus of the invention is not limited to the embodiments described above, and the parts and members constituting the fixing device may be replaced by arbitrary ones that exert the similar functions and may contain other constitutions.

In the aforementioned embodiment, heat is applied from the side of the fixing roller, but heat may be applied from the side of the pressure roller.

### EXAMPLES

### 1 Production of Liquid Developer

### Example 1

### Preparation of Insulating Liquid

A liquid containing an unsaturated fatty acid triglyceride and a liquid containing a fatty acid monoester used as an insulating liquid were prepared in the following manner.

### Preparation of Liquid Containing Unsaturated Fatty Acid Triglyceride

Crude soybean oil was purified in the same manner to provide purified soybean oil.

Crude soybean was preliminarily purified by a low temperature crystallization method using methanol, diethyl ether, petroleum ether, acetone or the like.

300 parts by volume of the crude soybean oil having been preliminarily purified (first preliminarily purified oil) was placed in a flask, and then 100 parts by volume of boiling water was placed in the flask, followed by plugging the flask.

The flask was shaken for mixing the crude soybean oil having been preliminarily purified (first preliminarily purified oil) and boiling water.

The flask was allowed to stand until the mixed liquid in the flask was separated into three layers.

After confirming the separation, the flask was placed in a freezing chamber and allowed to stand for 24 hours.

Thereafter, a component that was not frozen was placed in another flask.

The component that was not frozen was repeatedly subjected to the same purifying operation, and the resulting component that was not frozen was taken out and designated as crude soybean oil having been preliminarily purified (second preliminarily purified oil).

100 parts by volume of the crude soybean oil having been preliminarily purified (second preliminarily purified oil) obtained above and 35 parts by volume of activated clay constituted mainly by hydrated aluminum silicate were mixed and stirred in a flask.

The resulting mixture was stored under increased pressure (0.18 MPa) for 48 hours for completely precipitating activated clay.

Thereafter, the precipitate was removed to obtain purified soybean oil (hereinafter, referred simply to soybean oil). Soybean oil contains an unsaturated fatty acid triglyceride containing linoleic acid as the major component, and the content of the unsaturated fatty acid triglyceride was 98% by weight based on the amount of the soybean oil. The content of linoleic acid component was 53% by mol based on the total amount of the fatty acid component.

### Preparation of Liquid Containing Fatty Acid Monoester

A part of the soybean oil and methanol were subjected to ester exchange reaction, and glycerin formed through the reaction was removed, whereby a liquid constituted mainly by a fatty acid monoester was obtained. The liquid was purified to obtain soybean oil fatty acid methyl ester having a content of a fatty acid monoester of 99.9% by weight. The fatty acid monoester thus obtained was constituted mainly by an unsaturated fatty acid monoester, such as methyl oleate, methyl linoleate, methyl α-linolenate, and a saturated fatty acid monoester, such as methyl palmitate and methyl stearate.

### Preparation of Toner Particles

### Preparation of Colorant Master Solution

A mixture (50/50 by mass) of a polyester resin (softening temperature: 99° C., acid value: 7.7 KOHmg/g) and a cyan pigment (Pigment Blue 15:3, produced by Dainichiseika Color & Chemicals Mfg. Co., Ltd.) as a coloring agent was prepared. The components were mixed with a 20-L Henschel mixer to obtain a raw material for producing a toner.

The raw material (mixture) was kneaded with a biaxial kneading extruder. The kneaded product extruded from the extrusion port of the biaxial kneading extruder was cooled.

The kneaded product thus cooled was coarsely pulverized to form powder having an average particle diameter of 1.0 mm or less. A hammer mill was used for pulverization of the kneaded product.

Methyl ethyl ketone was added to the kneaded product powder to make the solid content to 30% by weight, and the mixture was subjected to wet dispersion with Eiger Motor Mill (Model M-1000, produced by Eiger Machinery, Inc., U.S.) to prepare a colorant master solution.

### Preparation of Resin Solution

200 parts by weight of methyl ethyl ketone and 73 parts by weight of the polyester resin were added to 33 parts by weight of the colorant master solution and mixed with Eiger Motor Mill (Model M-1000, produced by Eiger Machinery, Inc., U.S.) to prepare a resin solution. The pigment was finely dispersed uniformly in the solution.

### Preparation of Aqueous Emulsion

500 parts by weight of the resin solution and 45.5 parts by weight of methyl ethyl ketone were placed in a 2-L separable flask equipped with Maxblend agitation blades to make the solid content of the resin solution to 55%.

41.7 parts by weight of 1 N aqueous ammonia (1.1 molar equivalent ratio to the total amount of carboxyl groups of the polyester resin) was added to the resin solution in the flask, and the mixture was sufficiently agitated at a revolution number of 210 rpm (peripheral speed of agitation blades: 0.71 m/s). Thereafter, 133 parts by weight of deionized water was added thereto under agitation. The temperature of the solution in the flask was adjusted to 25° C., and 133 parts by weight of deionized water was added dropwise to the resin solution under agitation to effect phase inversion emulsification, whereby an aqueous emulsion having the dispersoid including the resin material dispersed therein was obtained.

### Production of Aggregated Particles by Aggregation

285 parts by weight of deionized water was added to the aqueous emulsion under agitation to make the total amount of the 1 N aqueous ammonia and water to 593 parts by weight. Subsequently, 2.6 parts by weight of an anionic emulsifier, Emal 0 (produced by Kao Corp.), was dissolved in 2.6 parts by weight of deionized water and added to the aqueous emulsion.

Thereafter, 300 parts by weight of a 3.5% ammonium sulfate aqueous solution was added dropwise to the aqueous emulsion at a revolution number of agitation of 150 rpm (peripheral speed of agitation blades: 0.54 m/s) while maintaining the temperature of the aqueous emulsion to 25° C. to obtain a diameter of the aggregated product of the dispersoid of 3.5 μm. After completing the dropwise addition, the agitation operation was continued until the particle diameter of the aggregated product of the dispersoid was increased to 5.0 μm, and thus the aggregation operation was completed.

The organic solvent was distilled off under reduced pressure from the resulting aggregated product dispersion liquid to obtain aggregated particles.

### Preparation of Liquid Developer

100 parts by weight of the aggregated particles obtained in the aforementioned manner, 200 parts by weight of soybean oil fatty acid methyl ester, 2.5 parts by weight of a polyamine fatty acid polycondensate (Solsperse 13940, a trade name, produced by Lubrizol Corp. Japan) and 1 part by weight of positively charging silica fine particles having been subjected to hydrophobic treatment with dimethylaminosilane (average particle diameter: 40 nm) were placed in a ceramic pot (internal capacity: 600 mL), and zirconia balls (ball diameter: 1 mm) were placed in the ceramic pot to make the volume filling rate to 25%. The mixture in the pot was pulverized with a desktop pot mill at a revolution number of 210 rpm (min⁻¹) for 120 hours, and the dispersion liquid in the pot was separated from the zirconia balls to obtain a toner particle dispersion liquid.

Thereafter, 300 parts by weight of purified soybean oil was added to the resulting toner particle dispersion liquid, followed by pulverizing for 24 hours, to obtain a liquid developer.

The resulting liquid developer had an average particle diameter (volume average particle diameter) of the toner particles of 1.9 μm and a standard deviation of particle diameter among the toner particles of 0.54 μm. The viscosity of the liquid developer measured with a vibration viscometer at 25° C. according to JIS Z8809 was 190 mPa·s. The insulating liquid had an electric resistance of 8×10¹² Ωcm, the liquid developer had an electric resistance of 2.1×10¹² Ωcm. The average particle diameter and the particle size distribution of the toner particles were measured with a particle analyzer, Mastersizer 2000 (produced by Malvern Instruments, Ltd.).

### Examples 2 to 5

Liquid developers were produced in the same manner as in Example 1 except that the average particle diameter and the content of the silica fine particles were changed as shown in Table 1-4.

### Examples 6 to 8

Liquid developers were produced in the same manner as in Example 1 except that the amounts of the fatty acid monoester and the unsaturated fatty acid triglyceride and at least one of the raw materials for producing them were changed as shown in Tables 1-2 and 1-3.

### Examples 9 and 10

Liquid developers were produced in the same manner as in Example 1 except that the content of the polymer dispersant was changed as shown in Table 1-4.

### Examples 11 and 12

Liquid developers were produced in the same manner as in Example 1 except that the raw materials for producing the insulating liquid were changed as shown in Tables 1-2 and 1-3.

### Examples 13 to 15

Liquid developers were produced in the same manner as in Example 1 except that the resin material constituting the toner particles was changed as shown in Table 1-1.

### Comparative Examples 1 and 2

Liquid developers were produced in the same manner as in Example 1 except that the silica fine particles were changed as shown in Table 1-4.

### Comparative Examples 3 and 4

Liquid developers were produced in the same manner as in Example 1 except that the content of the silica fine particles were changed as shown in Table 1-4.

### Comparative Example 5

A liquid developer was produced in the same manner as in Example 1 except that the soybean oil fatty acid methyl ester was replaced by soybean oil.

### Comparative Example 6

A liquid developer was produced in the same manner as in Example 1 except that the silica fine particles were not added.

### Comparative Example 7

A liquid developer was produced in the same manner as in Example 1 except that the polymer dispersant was not added.

For Examples and Comparative Examples, Tables 1-1 to 1-4 show the kind of the resin used; the raw material, the content in the insulating liquid and the kinds and contents of the contained fatty acid components of the unsaturated fatty acid triglyceride; the raw material, the content in the insulating liquid, the kinds and contents of the contained fatty acid components and the kind of the alcohol component used for ester exchange of the fatty acid monoester; the charging property, the average particle diameter and the content of the silica fine particles; and the content of the polymer dispersant. In Table 1-1, PEs represents a polyester resin, EP represents an epoxy resin, and HO rapeseed oil represents high-oleic rapeseed oil.

TABLE 1-1

| | Resin material | | |
|---|---|---|---|
| | | Softening point | Acid value |
| | Kind | (° C.) | (KOHmg/g) |
| Example 1 | PEs | 99 | 7.7 |
| Example 2 | PEs | 99 | 7.7 |
| Example 3 | PEs | 99 | 7.7 |
| Example 4 | PEs | 99 | 7.7 |
| Example 5 | PEs | 99 | 7.7 |
| Example 6 | PEs | 99 | 7.7 |
| Example 7 | FEs | 99 | 7.7 |
| Example 8 | PEs | 99 | 7.7 |
| Example 9 | PEs | 99 | 7.7 |
| Example 10 | PEs | 99 | 7.7 |
| Example 11 | PEs | 99 | 7.7 |
| Example 12 | PEs | 99 | 7.7 |
| Example 13 | PEs | 114 | 21 |
| Example 14 | PEs | 111 | 0.1 |
| Example 15 | EP | 128 | 8.0 |
| Comparative | PEs | 99 | 7.7 |
| Example 1 | | | |
| Comparative | PEs | 99 | 7.7 |
| Example 2 | | | |
| Comparative | PEs | 99 | 7.7 |
| Example 3 | | | |
| Comparative | PEs | 99 | 7.7 |
| Example 4 | | | |
| Comparative | PEs | 99 | 7.7 |
| Example 5 | | | |
| Comparative | PEs | 99 | 7.7 |
| Example 6 | | | |
| Comparative | PEs | 99 | 7.7 |
| Example 7 | | | |

TABLE 1-2

| | Insulating Liquid | | | | |
|---|---|---|---|---|---|
| | Unsaturated fatty acid triglyceride | | | | |
| | | Unsaturated fatty acid component | | | |
| | | | Content of | | |
| | | Content of | divalent or | | |
| | | monovalent | higher | Content of | |
| | | unsaturated fatty | unsaturated fatty | saturated fatty | |
| | Raw material | acid component | acid component | acid component | Content X |
| | (Vegetable oil) | (% by mol) | (% by mol) | (% by mol) | (% by weight) |
| Example 1 | soybean oil | 23.8 | 60.1 | 16.1 | 60.0 |
| Example 2 | soybean oil | 23.8 | 60.1 | 16.1 | 60.0 |
| Example 3 | soybean oil | 23.8 | 60.1 | 16.1 | 60.0 |
| Example 4 | soybean oil | 23.8 | 60.1 | 16.1 | 60.0 |
| Example 5 | soybean oil | 23.8 | 60.1 | 16.1 | 60.0 |
| Example 6 | soybean oil | 23.8 | 60.1 | 16.1 | 70.6 |
| Example 7 | soybean oil | 23.8 | 60.1 | 16.1 | 91.3 |
| Example 8 | soybean oil | 23.8 | 60.1 | 16.1 | 56.5 |
| Example 9 | soybean oil | 23.8 | 60.1 | 16.1 | 60.0 |
| Example 10 | soybean oil | 23.8 | 60.1 | 16.1 | 60.0 |
| Example 11 | soybean oil | 23.8 | 60.1 | 16.1 | 60.0 |
| Example 12 | HO rapeseed oil | 75.0 | 17.4 | 7.6 | 60.0 |
| Example 13 | soybean oil | 23.8 | 60.1 | 16.1 | 60.0 |
| Example 14 | soybean oil | 23.8 | 60.1 | 16.1 | 60.0 |
| Example 15 | soybean oil | 23.8 | 60.1 | 16.1 | 60.0 |

| | Insulating Liquid | | | | |
|---|---|---|---|---|---|
| | Unsaturated fatty acid triglyceride | | | | |
| | | Unsaturated fatty acid component | | | |
| | | | Content of | | |
| | | Content of | divalent or | Content of | |
| | | monovalent fatty | higher fatty acid | saturated fatty | |
| | Raw material | acid component | component | acid component | Content X |
| | (Vegetable oil) | (% by mol) | (% by mol) | (% by mol) | (% by weight) |
| Comparative | soybean oil | 23.8 | 60.1 | 16.1 | 60.0 |
| Example 1 | | | | | |
| Comparative | soybean oil | 23.8 | 60.1 | 16.1 | 60.0 |
| Example 2 | | | | | |
| Comparative | soybean oil | 23.8 | 60.1 | 16.1 | 60.0 |
| Example 3 | | | | | |
| Comparative | soybean oil | 23.8 | 60.1 | 16.1 | 60.0 |
| Example 4 | | | | | |
| Comparative | soybean oil | 23.8 | 60.1 | 16.1 | 100 |
| Example 5 | | | | | |
| Comparative | soybean oil | 23.8 | 60.1 | 16.1 | 60.0 |
| Example 6 | | | | | |
| Comparative | soybean oil | 23.8 | 60.1 | 16.1 | 60.0 |
| Example 7 | | | | | |

TABLE 1-3

| | Insulating Liquid | | | | | |
|---|---|---|---|---|---|---|
| | Fatty acid monoester | | | | | |
| | | Unsaturated fatty acid | | | | |
| | | component | | | | |
| | | | Content of | | | |
| | | Content of | divalent or | | | |
| | | monovalent | higher | | | |
| | | unsaturated | unsaturated | | | |
| | Raw material | fatty acid | fatty acid | Kind of alcohol | | |
| | (Vegetable | component | component | used for ester | Content Y | |
| | oil) | (% by mol) | (% by mol) | exchange | (% by weight) | X/Y |
| Example 1 | soybean oil | 23.8 | 60.1 | methanol | 40.0 | 1.5 |
| Example 2 | soybean oil | 23.8 | 60.1 | methanol | 40.0 | 1.5 |
| Example 3 | soybean oil | 23.8 | 60.1 | methanol | 40.0 | 1.5 |
| Example 4 | soybean oil | 23.8 | 60.1 | methanol | 40.0 | 1.5 |
| Example 5 | soybean oil | 23.8 | 60.1 | methanol | 40.0 | 1.5 |
| Example 6 | soybean oil | 23.8 | 60.1 | methanol | 29.4 | 2.4 |
| Example 7 | soybean oil | 23.8 | 60.1 | methanol | 8.7 | 10.5 |
| Example 8 | soybean oil | 23.8 | 60.1 | methanol | 43.5 | 1.3 |
| Example 9 | soybean oil | 23.8 | 60.1 | methanol | 40.0 | 1.5 |
| Example 10 | soybean oil | 23.8 | 60.1 | methanol | 40.0 | 1.5 |
| Example 11 | safflower oil | 14.0 | 75.9 | methanol | 40.0 | 1.5 |
| Example 12 | soybean oil | 23.8 | 60.1 | methanol | 40.0 | 1.5 |
| Example 13 | soybean oil | 23.8 | 60.1 | methanol | 40.0 | 1.5 |
| Example 14 | soybean oil | 23.8 | 60.1 | methanol | 40.0 | 1.5 |
| Example 15 | soybean oil | 23.8 | 60.1 | methanol | 40.0 | 1.5 |

| | Insulating Liquid | | | | | |
|---|---|---|---|---|---|---|
| | Fatty acid monoester | | | | | |
| | | Unsaturated fatty acid | | | | |
| | | component | | | | |
| | | Content of | Content of | | | |
| | | monovalent | divalent or | | | |
| | Raw material | fatty acid | higher fatty | Kind of alcohol | | |
| | (Vegetable | component | acid component | used for ester | Content Y | |
| | oil) | (% by mol) | (% by mol) | exchange | (% by weight) | X/Y |
| Comparative | soybean oil | 23.8 | 60.1 | methanol | 40.0 | 1.5 |
| Example 1 | | | | | | |
| Comparative | soybean oil | 23.8 | 60.1 | methanol | 40.0 | 1.5 |
| Example 2 | | | | | | |
| Comparative | soybean oil | 23.8 | 60.1 | methanol | 40.0 | 1.5 |
| Example 3 | | | | | | |
| Comparative | soybean oil | 23.8 | 60.1 | methanol | 40.0 | 1.5 |
| Example 4 | | | | | | |
| Comparative | — | — | — | — | 0 | — |
| Example 5 | | | | | | |
| Comparative | soybean oil | 23.8 | 60.1 | methanol | 40.0 | 1.5 |
| Example 6 | | | | | | |
| Comparative | soybean oil | 23.8 | 60.1 | methanol | 40.0 | 1.5 |
| Example 7 | | | | | | |

TABLE 1-4

| | Silica fine particles | | | Content of polymer |
|---|---|---|---|---|
| | | | Content per 100 parts | dispersant per 100 |
| | | Average particle | by weight of toner | parts by weight of |
| | | diameter | particles | toner particles |
| | Charging property | (nm) | (part by weight) | (part by weight) |
| Example 1 | positive | 40 | 1.0 | 2.5 |
| Example 2 | positive | 40 | 5.0 | 2.5 |
| Example 3 | positive | 40 | 0.2 | 2.5 |
| Example 4 | positive | 90 | 5.0 | 2.5 |
| Example 5 | positive | 10 | 0.2 | 2.5 |
| Example 6 | positive | 40 | 1.0 | 2.5 |
| Example 7 | positive | 40 | 1.0 | 2.5 |
| Example 8 | positive | 40 | 1.0 | 2.5 |
| Example 9 | positive | 40 | 1.0 | 0.2 |
| Example 10 | positive | 40 | 1.0 | 8.0 |
| Example 11 | positive | 40 | 1.0 | 2.5 |
| Example 12 | positive | 40 | 1.0 | 2.5 |
| Example 13 | positive | 40 | 1.0 | 2.5 |
| Example 14 | positive | 40 | 1.0 | 2.5 |
| Example 15 | positive | 40 | 1.0 | 2.5 |
| Comparative Example 1 | positive | 3.0 | 1.0 | 2.5 |
| Comparative Example 2 | positive | 120 | 1.0 | 2.5 |
| Comparative Example 3 | positive | 40 | 0.05 | 2.5 |
| Comparative Example 4 | positive | 90 | 6.0 | 2.5 |
| Comparative Example 5 | positive | 10 | 1.0 | 2.5 |
| Comparative Example 6 | — | — | 0 | 2.5 |
| Comparative Example 7 | positive | 40 | 1.0 | 0 |

### 2 Evaluation

The liquid developers thus obtained were evaluated in the following manner.

### 2-1 Charging Property

The liquid developers obtained in Examples and Comparative Examples were measured for electric potential with a microscope laser zeta potentiometer, Model ZC-2000, produced by Mircotec Niti-on Co., Ltd., and evaluated based on the following five grades.

The measurement was carried out in the following manner. The liquid developer was diluted with a diluent solvent and placed in a transparent cell of 10 mm square. The liquid developer was applied with a voltage of 300 V with a distance of electrodes of 9 mm, and simultaneously the moving velocity of the particles in the cell was observed with the microscope, with which the moving velocity was calculated to obtain the zeta potential.
AA: potential of +100 mV or more
A: potential of +85 mV or more and less than +100 mV
B: potential of +70 mV or more and less than +85 mV
C: potential of +50 mV or more and less than +70 mV
D: potential of less than +50 mV

### 2-2 Fixing Strength

Images having a prescribed pattern were formed on recording paper (high quality paper, LPCPPA4, produced by Seiko Epson Corporation) with the liquid developers obtained in Examples and Comparative Examples using an image forming apparatus shown in FIG. 1. An amorphous silicon photoreceptor was used as the photoreceptor. The images were then heat fixed by using a fixing device shown in FIG. 3 with the temperature of the heat fixing roller set to 100° C.

Thereafter, the non-offset area was confirmed, and then the fixed image on the recording paper was rubbed with a rubber eraser (sand eraser, LION 261-11, produced by Lion Office Products Corp.) twice with a pressing load of 1.5 kgf. The remaining rate of the image density was measured with X-Rite Model 404, produced by X-Rite, Inc., and evaluated based on the following five grades.
AA: image density remaining rate of 95% or more
A: image density remaining rate of 90% or more and less than 95%
B: image density remaining rate of 80% or more and less than 90%
C: image density remaining rate of 70% or more and less than 80%
D: image density remaining rate of less than 70%

### 2-3 Image Density

Images having a prescribed pattern were formed on recording paper (high quality paper, LPCPPA4, produced by Seiko Epson Corporation) with the liquid developers obtained in Examples and Comparative Examples using an image forming apparatus according to an embodiment of the invention shown in FIG. 1. The images were then heat fixed by using a fixing device shown in FIG. 3 with the temperature of the heat fixing roller set to 100° C.

The image density of the toner image formed on the recording paper was measured with a color difference meter, produced by X-Rite, Inc.

### 2-4 Storage Stability

The liquid developers obtained in Examples and Comparative Examples were allowed to stand under an environment at a temperature of from 15 to 25° C. for 6 months. Thereafter, the state of the toner contained in the liquid developer was visually observed and evaluated based on the following five grades.
AA: Completely no floatage or precipitation due to aggregation of toner particles found
A: Substantially no floatage or precipitation due to aggregation of toner particles found
B: Slight floatage and precipitation due to aggregation of toner particles found without problem upon using as liquid developer
C: Floatage and precipitation due to aggregation of toner particles clearly found
D: Floatage and precipitation due to aggregation of toner particles considerably found

The results obtained are shown in Table 2.

TABLE 2

| | Evaluation | | | |
|---|---|---|---|---|
| | | Fixing | Image | Storage |
| | Charging property | strength | density | stability |
| Example 1 | AA | AA | 1.60 | AA |
| Example 2 | A | AA | 1.52 | AA |
| Example 3 | A | AA | 1.54 | AA |
| Example 4 | B | AA | 1.46 | AA |
| Example 5 | B | AA | 1.48 | AA |
| Example 6 | A | AA | 1.51 | AA |
| Example 7 | A | A | 1.51 | AA |
| Example 8 | A | AA | 1.53 | AA |
| Example 9 | A | A | 1.46 | AA |
| Example 10 | A | A | 1.45 | AA |
| Example 11 | AA | AA | 1.56 | A |
| Example 12 | AA | A | 1.57 | AA |
| Example 13 | A | AA | 1.47 | AA |
| Example 14 | A | AA | 1.49 | AA |
| Example 15 | B | A | 1.45 | AA |
| Comparative Example 1 | C | A | 1.32 | B |
| Comparative Example 2 | C | B | 1.36 | B |
| Comparative Example 3 | D | A | 1.13 | D |
| Comparative Example 4 | D | B | 1.16 | B |
| Comparative Example 5 | B | D | 1.36 | B |
| Comparative Example 6 | D | B | 1.10 | C |
| Comparative Example 7 | D | B | 1.16 | C |

It was understood from the results shown in Table 2 that Examples were excellent in all charging property, fixing strength, image density and storage stability, but in Comparative Examples, on the other hand, no sufficient result was obtained.

Production and evaluation of liquid developers were carried out in the same manner as above except that Pigment Red 122, Pigment Yellow 180 and carbon black (Printex L, produced by Degussa AG) were used instead of the cyan pigment, and as a results, the similar results as above were obtained.

Evaluation of image density and fixing strength were carried out in the same manner as above except that the photoreceptor was changed to a surface-coated organic photoreceptor, and as a result, the similar results as above were obtained.

What is claimed is:

1. A liquid developer comprising:
an insulating liquid having dispersed therein toner particles,
silica fine particles subjected to hydrophobic treatment, and
a polymer dispersant,
the silica fine particles having an average particle diameter of from 5 to 100 nm, and a content of the silica fine particles being from 0.1 to 5.0 parts by weight per 100 parts by weight of the toner particles, and
the insulating liquid containing an unsaturated fatty acid triglyceride and a fatty acid monoester.

2. The liquid developer as claimed in claim 1, wherein the silica fine particles have positive charging property.

3. The liquid developer as claimed in claim 1, wherein the polymer dispersant is a polyamine-fatty acid polycondensate.

4. The liquid developer as claimed in claim 1, wherein a content of the polymer dispersant is from 0.5 to 7.5 parts by weight per 100 parts by weight of the toner particles.

5. The liquid developer as claimed in claim 1, wherein a content X (% by weight) of the unsaturated fatty acid triglyceride and a content Y (% by weight) of the fatty acid monoester satisfy relationship, 1≦X/Y≦9.

6. The liquid developer as claimed in claim 1, wherein a resin contained in a material constituting the toner particles has an acid value of from 5 to 20 KOHmg/g.

7. An image forming apparatus for forming an image on a recording medium by using the liquid developer as claimed in claim 1, the image forming apparatus comprising:
a liquid developer storing part that stores the liquid developer;
a developing part that forms an image by using the liquid developer fed from the liquid developer storing part;
a transferring part that transfers the image formed in the developing part, onto the recording medium to form a transferred image;
a recovering part that recovers the liquid developer remaining in the developing part; a transporting part that transports the recovered liquid developer to the liquid developer storing part; and
a fixing part that fixes the transferred image formed on the recording medium onto the recording medium.

8. The image forming apparatus as claimed in claim 7, wherein the developing part comprises a developing roller having on a surface thereof a layer of the liquid developer, and a compressing member that localizes the toner particles to a vicinity of a surface of the developing roller within the layer.

9. The image forming apparatus as claimed in claim 8, wherein the compressing member applies an electric field having the same polarity as the toner particles to the layer, so as to localize the toner particles to a vicinity of a surface of the developing roller within the layer.
